(19) United States
(12) Patent Application Publication
(10) Pub. No.: US 2005/0231846 A1
(43) Pub. Date: Oct. 20, 2005

(54) Write-once read-many hard disk drive using a WORM pointer

(75) Inventors: Daniel James Winarski, Tucson, AZ (US); Robert George Emberty, Tucson, AZ (US); Craig Anthony Klein, Tucson, AZ (US); Nils Haustein, Zornheim (DE)

Correspondence Address: Allen K. Bates;IBM Corporation - 90A/9032-1, 9000 South Rita Road, Tucson, AZ, 85744, US

(73) Assignee: International Business Machines Corporation

(21) Appl. No.: 10/824,901

(22) Filed: Apr. 14, 2004

(51) Int. Cl. G11B 5/09

(52) U.S. Cl. 360/69

(57) ABSTRACT

Disclosed are a system, an apparatus, a method and an article of manufacture to provide for writing WORM (write once read many) data to a data storage device. A WORM pointer memory is used for maintaining an inventory of LBAs (logical block addresses) where WORM data may be written on the data storage media of the data storage device. The WORM pointer memory is a tamper proof memory device to maintain data integrity with respect to WORM data.

### CROSS-REFERENCES TO RELATED APPLICATIONS

The present application is related to application Ser. No. ______, entitled “Write-Once Read-Many Hard Disk Drive Using a WORM LBA Indicator” Docket # TUC9-2004-0008, filed on an even date herewith, the disclosure of which is hereby incorporated by reference in its entirety.

### TECHNICAL FIELD

This invention relates to data recording information storage systems and methods related thereto. In particular, the invention relates to data recording disk drives and host computers having means for selectively and permanently disabling overwrite modes of the disk drives when the data written to these disk drives needs to be write-once, read-many (WORM).

### BACKGROUND

It is often necessary in computer data processing environments (from very small home computers to very large enterprise computers) to store data sets (e.g. data, program files, etc.) onto storage media in an archival format that cannot be altered. Write-Once Read Many (WORM) techniques using optical media are typically employed to provide this capability. Usually, these data sets are copied or moved to the optical media from a direct access storage device (DASD), such as a disk drive, as part of a migration, backup or archive operation. Many different types of rewritable storage media (e.g. hard disk drive, magnetic tape, optical disks, etc.) are used in data processing enterprises for space management and data backup operations. Space management includes data migration, which is the act of moving infrequently used data sets from primary storage to migration storage. Backing up is the act of periodically copying data sets, or portions thereof, from primary storage to backup storage in order to create one or more backup versions of the data sets which can be recovered following a disaster event. Rewritable storage media are often used for migration and backup because the data sets recorded thereon usually become obsolete, and the migration and backup disks can be reused to record new migration and backup data.

Data archival is the act of saving a specific version of a data set (e.g., for record retention purposes) for an extended period of time. The data set is placed in archive storage pursuant to command by a user or data processing administrator. Archived data sets are often preserved for legal purposes or for other reasons of importance to the data processing enterprise. It is therefore important that archived data volumes be capable of certification, meaning that automatic machine procedures are in place for certifying that the data sets written to the archive volume have not been altered or rewritten. There are some applications in which it is necessary or highly advantageous to provide a permanent, non-alterable version of a file. For example, legal documents, such as Securities and Exchange Commission (SEC) records, stock trading records, business dealings, e-mail, insurance records, etc. should be permanently stored on a media that cannot be altered once the files have been written to the storage device. Similar requirements for permanence exist for medical records and images. Traditionally, WORM functionality has been provided by ablative or alloy optical media used in optical disk drives.

Disks recorded according to WORM techniques are often used for archival purposes because they can be written only once. There are at least two distinct methods being offered in the marketplace for WORM recording: WORM using ablative media, and Continuous Composite Write-once (CCW) using rewritable media, for example, magnetic tape. Ablative WORM disks are recorded using a high power laser beam which permanently ablates the media to form small pits which alter the reflectance of the media surface. When an incident laser beam (at a lower power level during read mode than during write operations) is focused on the media, there is produced an intensity modulated return beam containing the information recorded on the media. Ablative WORM thus provides a permanent audit trail of archived data based on the ablative nature of the recording media. In contrast, Continuous Composite Write-once (CCW) uses a rewritable media and a data storage drive that allows the rewritable media to be convertible from rewritable to read-only using drive firmware. Each media recording surface has a media descriptor table contained within a control track which defines the media as a unique media type. Previously manufactured drives will not recognize the media type, and therefore, will not read or write the media. The data on the media is therefore protected from being destroyed by such drives. There is also a storage state indicator within each sector of each track of the media that defines whether the sector is writable or read-only. When the indicator is in the “off” state the sector may be written. The writing process changes the state of the indicator to “on” or “read only,” which prevents any further writing on the sector. The problem with this CCW format is that a drive with altered microcode could easily ignore the logical WORM format indicator and freely rewrite the media. This rewritten media would appear as WORM when placed in a drive without altered microcode, and thus present data integrity issues.

Ablative WORM technology has been successfully marketed as superior to CCW technology due to the built-in tamper-resistant protection of the ablative media versus the perceived tamper protection offered by CCW drive firmware. However, the use of ablative technology has disadvantages with respect to the development time, development expense, and unit cost required for the drive and the media. Accordingly, a superior method is required for WORM data storage that reduces the substantial costs of ablative WORM yet provides greatly improved tamper resistance over CCW technology.

There is a need to provide such WORM functionality in a magnetic storage device, such as a hard disk drive (HDD) or a direct access storage device (DASD). One method of providing such functionality is to permit a manual change to the HDD such as setting an external switch or a jumper (pin or wire) to a write-inhibit position to prevent the magnetic storage media from being overwritten. This method suffers from the drawback that the mechanism is easily reversed to make the media writable once again, because the switch or jumper could be temporarily reset to permit alteration of the data, and then reset back to the write-inhibit position. Such a solution is unsatisfactory for the typical WORM applications, which require the integrity of the saved data be maintained, where a true WORM function is required. Therefore, a need exists for secure WORM functionality in a magnetic hard disk drive.

### SUMMARY OF THE INVENTION

Broadly defined, the present invention provides a system, an apparatus and a method for writing WORM data to a data storage device. A WORM pointer is used to maintain an inventory of logical block addresses (LBAs) where WORM data may be written on the data storage media of the data storage device. The WORM pointer is stored in a tamper proof memory device to maintain data integrity with respect to WORM data.

In method form, exemplary embodiments include a method for writing data on a data storage device, comprising: receiving a write command; obtaining a starting LBA and a LBA transfer length from the write command; obtaining a first WORM pointer from a WORM pointer memory; and in response to the starting LBA being greater than or equal to the WORM pointer, executing the write command to write WORM data to the data storage media of the data storage device.

Another exemplary embodiment includes a method for a host computer to write data to a data storage device, comprising: the host computer sending a first inquiry command to the data storage device; receiving a response from the data storage device to the first inquiry command; determining a device type of the data storage device from the response to the first inquiry command; sending a reserve command to the data storage device to reserve the data storage device; sending a second inquiry command to the data storage device; receiving a response from the data storage device to the second inquiry command; obtaining a starting LBA from the response to the second inquiry command; embedding the starting LBA in a write command; and writing the data to the data storage device using the write command.

In system embodiments the present invention provides a data storage system, comprising: a host computer comprising a data storage device interface; a data storage device comprising: a data storage media for storage of data; a processor for controlling said data storage device; a WORM pointer memory coupled to said processor for storage of a WORM pointer; a host device interface coupled to said processor for sending and receiving commands with respect to said host computer, wherein said data is stored as WORM data on said data storage media.

For a fuller understanding of the nature and advantages of the present invention, reference should be made to the following detailed description taken together with the accompanying drawings.

### BRIEF DESCRIPTION OF THE DRAWINGS

FIG. 1 shows a side view of a hard disk drive;

FIG. 2 shows a top view of a hard disk drive;

FIG. 3 shows the control circuitry of a hard disk drive;

FIG. 4 shows a computer system utilizing a hard disk drive;

FIG. 5 shows a typical format of a disk surface of a hard disk drive;

FIG. 6 shows a table of the format of a disk surface;

FIG. 7 shows an exemplary write command for writing data to a data storage device;

FIG. 8 shows a flowchart of the process for the direct writing of WORM data on a data storage device;

FIG. 9 shows an example of LBAs and the contents of a pointer memory before a WORM write operation is executed on a data storage device;

FIG. 10 shows an example of LBAs and the contents of a pointer memory after a WORM write operation is executed on a data storage device;

FIG. 11 shows an exemplary inquiry command for use with a data storage device;

FIG. 12 shows an example response from a data storage device to the exemplary inquiry command of FIG. 11;

FIG. 13 shows a flowchart of a process by a host computer to write WORM data to a data storage drive;

FIG. 14 shows an example of a reserve command for use with a data storage device;

FIG. 15 shows an example of a Release Command for use with a data storage device; and

FIG. 16 shows an example of a Write Verify command for use with a data storage device.

### DETAILED DESCRIPTION OF PREFERRED EMBODIMENTS

In the preferred embodiment a magnetic disk drive (also referred to as a disk drive or hard disk drive (HDD) is used to implement the present invention. Accordingly, the following description will proceed with reference to a magnetic disk drive. The use of a disk drive to describe the operation of the present invention does not preclude the use of the present invention on other data storage devices (e.g. optical data storage, magnetic tape, etc.).

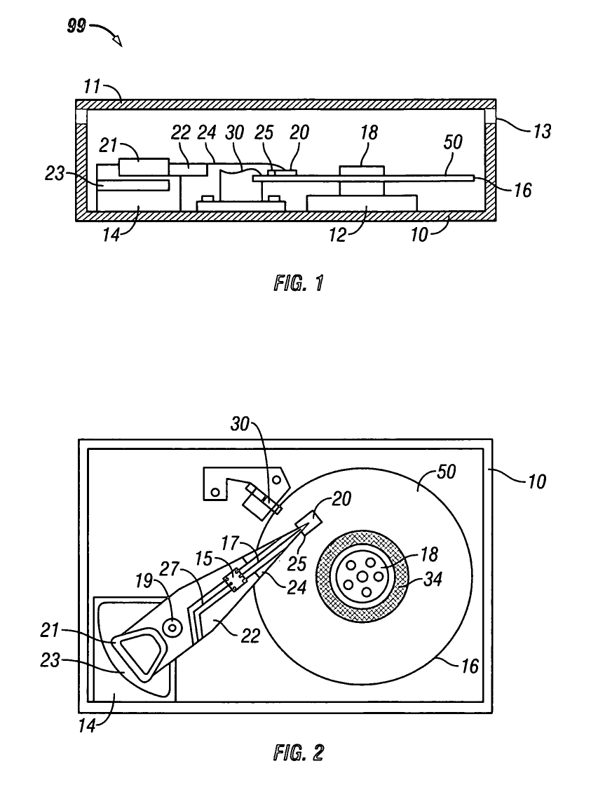

Referring first to FIG. 1, there is illustrated in sectional view a schematic of a disk drive 99 according to the present invention. For ease of illustration and explanation, the disk drive 99 depicted in FIGS. 1 and 2 is shown as having a single recording head and associated disk surface, although conventional disk drives typically have multiple heads, one on each side of multiple disks and the present invention applies equally to both multiple disk/head and single disk/head drives without limitation.

The disk drive 99 comprises a base 10 to which are secured a spindle motor 12, an actuator 14 and a cover 11. The base 10 and cover 11 provide a substantially sealed housing for disk drive 99. Typically, there is a gasket 13 located between base 10 and cover 11. A small breather port (not shown) for equalizing the air pressure between the interior of disk drive 99 and the outside environment is typically placed in a base 10 of larger HDDs. Smaller HDDs, such as the HDDs used in laptops and notebooks, may not need this small breather port due to the tiny amount of free cavity volume in smaller HDDs. This type of disk drive is described as being substantially sealed because the spindle motor 12 is located entirely within the housing and there is no external forced air supply for cooling the interior components. A magnetic recording disk 16 is connected to spindle motor 12 by means of spindle or hub 18 for rotation by spindle motor 12. A thin film 50 of lubricant is maintained on the surface of disk 16. Recording disk 16 is the data storage media for storage of data for disk drive 99. In alternative embodiments, the data storage media may comprise, for example, magnetic tape, optical storage media, etc., without limitation.

A read/write head or transducer 25 is formed on the trailing end of an air-bearing slider 20. Transducer 25 typically has an inductive write transducer and either a magnetoresistive (MR) or a giant magnetoresistive (GMR) read transducer, all of which are formed by thin-film deposition techniques as is known in the art. The slider 20 is connected to the actuator 14 by means of a rigid arm 22 and a flexible suspension 24, the flexible suspension 24 providing a biasing force which urges the slider 20 towards the surface of the recording disk 16. The arm 22, flexible suspension 24, and slider 20 with transducer 25 are referred to as the head-slider-arm (HSA) assembly.

During operation of disk drive 99, the spindle motor 12 typically rotates the disk 16 at a constant angular velocity (CAV), and the actuator 14 pivots on shaft 19 to move slider 20 in a gentle arc that is aligned generally radially across the surface of disk 16, so that the read/write transducer 25 may access different data tracks on disk 16. The actuator 14 is typically a rotary voice coil motor (VCM) having a coil 21 that moves in an arc through the fixed magnetic field of magnet assembly 23 when current is applied to coil 21. Alternately, arm 22, flexible suspension 24, slider 20, and transducer 25 could move along a radial line via a linear VCM (not shown).

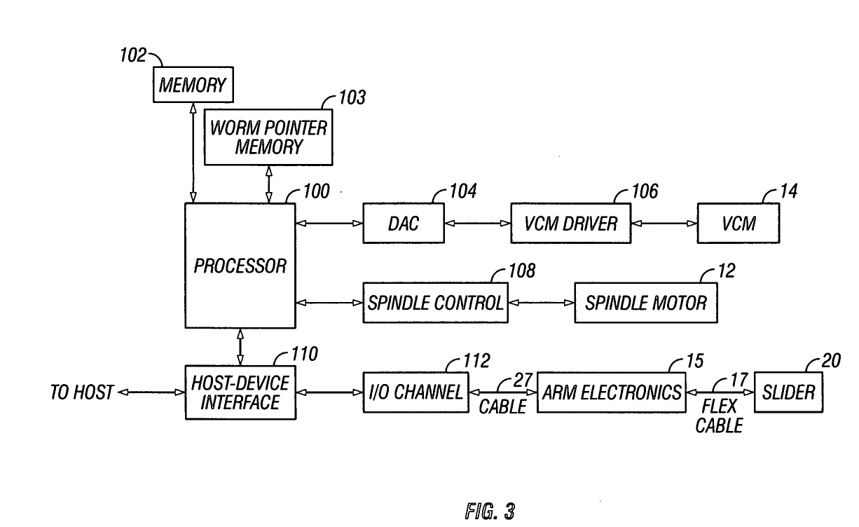

FIG. 2 is a top view of the interior of disk drive 99 with the cover 11 removed, and illustrates in better detail flexible suspension 24 which provides a force to the slider 20 to urge it toward the disk 16. The suspension may be a conventional type of suspension such as the well-known Watrous suspension, as described in U.S. Pat. No. 4,167,765. This type of suspension also provides a gimbaled attachment of the slider 20 that allows the slider 20 to pitch and roll as it rides on the air bearing. The data detected from disk 16 by transducer 25 is processed into a data readback signal by an integrated circuit signal amplification and processing circuit in arm electronics (AE) 15, located on arm 22. The signals between transducer 25 and arm electronics 15 travel via flex cable 17. The signals between arm electronics 15 and I/O channel 112 of FIG. 3 travel via cable 27. Arm 22 rotates about pivot 19. When I/O is completed, actuator 14 may rotate slider 20 toward the inner diameter of disk 16 and park slider landing zone 34. Landing zone 34 is tyupically rougher than the remainder of disk 16, to mitigate stiction between slider 20 and disk 16 when disk drive 99 is spun up to speed after a power-down period of time. Alternately, load/unload ramp 30, which is mounted to the base 10, contacts suspension 24 and lifts the slider 20 away from disk 16 when the actuator 14 rotates the slider 20 toward the disk outside diameter when disk drive 99 is powered down. When disk drive 99 is spun back up to speed after a power-down period of time, actuator 14 either moves slider off of landing zone 34 or load/unload ramp 30 and onto the data area of disk 16.

Referring now to FIG. 3, drive electrical components include a processor 100 that processes instructions contained in memory 102 to control disk drive 99. Processor 100 may comprise an off-the-shelf processor, custom processor, FPGA (Field Programmable Gate Array), ASIC (Application Specific Integrated Circuit), discrete logic, etc. Memory 102 is used to hold variable data, stack data, and executable instructions. Memory 102 is preferably RAM (Random Access Memory). Processor 100 is coupled to and accesses worm pointer memory 103, wherein a WORM pointer (WORM_PTR) is stored. The worm pointer memory 103 is preferably EPROM (Erasable Programmable Read Only Memory). EPROMs are typically erased with UV light. In the preferred embodiment, worm pointer memory 103 is located inside of disk drive 99 to prevent the erasure of worm pointer memory 103 without mechanically opening sealed disk drive 99. Alternatively, worm pointer memory 103 may be located inside a sealed portion of a data storage device to further provide tamper resistance. The sealed portion of the data storage device may require special tooling, breakage of seals, etc. to clearly indicate any possible tampering of worm pointer memory 103. Additionally, worm pointer memory 103 may comprise PROM (Programmable Read Only Memory), FLASH or EEPROM. FLASH is a form of EEPROM (Electrically Erasable Programmable Read Only Memory). EEPROM may be erased one byte at a time, whereas FLASH must be erased in blocks. Because of its block-oriented nature and the fixed block architecture of hard disk drives, FLASH memory is commonly used as a supplement to or replacement for hard disk drives in portable computers.

Processor 100 sends digital signals to digital-to-analog converter (DAC) 104, for conversion to low-power analog signals. These low-power analog signals are received by VCM driver 106. VCM driver 106 amplifies the low-power analog signals into high-power signals to drive VCM 14. Processor 100 also controls and is connected to the spindle motor 12 via spindle controller 108. VCM 14 is energized by the VCM driver 106 which receives analog voltage signals from DAC 104. VCM driver 106 delivers current to the coil of VCM 14 in one direction to pivot the head-slider-arm assembly radially outward and in the opposite direction to pivot the head-slider-arm assembly radially inward. The spindle controller 108 controls the current to the armatures of spindle motor 12 to rotate the motor at a constant rotational speed, which is also known as constant angular velocity or CAV, during drive operation. In addition, the spindle controller 108 provides a status signal to processor 100 indicating whether or not spindle motor 12 is rotating at its operating speed via the back electromotive force (BEMF) voltage from spindle motor 12, which will have a nonzero value when motor 12 is rotating. Spindle motor 12 is commonly a brushless DC motor with three windings or three sets of windings.

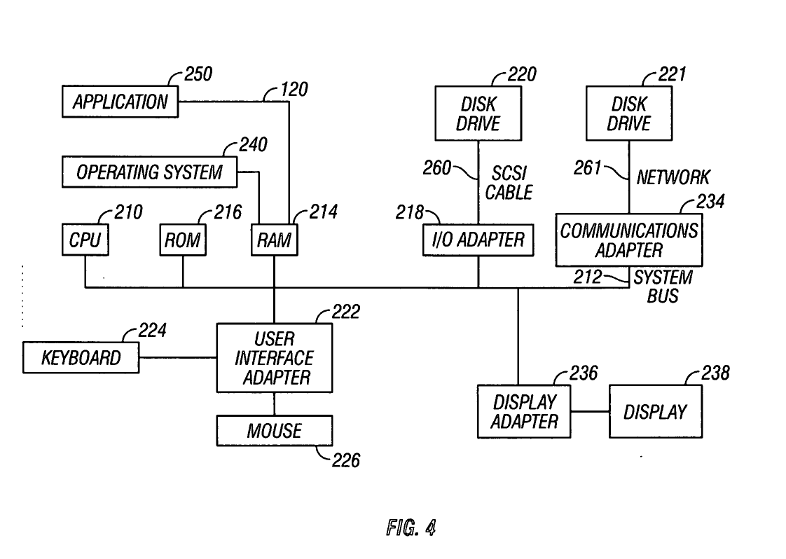

Host-device interface 110 is coupled to and communicates with processor 100 to send and receive commands with respect to host computer 120. Additionally, host-device interface 110 receives data from host computer 120 (FIG. 4) and sends it to I/O channel 112, where the data is encoded before being sent via cable 27 to arm electronics 15. Typical encoding is via a convolution encoder. From arm electronics 15, the encoded data is sent via flex cable 17 to the inductive write transducer on slider 20 resulting in the encoded data being written to disk 16. Similarly, when data is requested by host computer 120, the MR or GMR read transducer on slider 20 reads the encoded data off of disk 16, and sends that data to arm electronics 15 via flex cable 17. From arm electronics 15, the encoded data is sent via cable 27 to be decoded by I/O channel 112 before being sent to host computer 120 via host-device interface 110. A typical decoder is a PRML (partial-response, maximum likelihood) decoder.

FIG. 4 illustrates a typical hardware configuration of a host computer 120 utilizing the hard disk drive shown in FIGS. 1 and 2. Although the following description will proceed with reference to a host computer to describe the operation of the present invention, this does not preclude the use of the present invention on other devices (e.g. personal computer, server, storage controller, storage server, automated data storage library, virtual tape server, etc.) that may interface to hard disk drives or other data storage devices (e.g. optical data storage, magnetic tape, etc.). Any reference herein to a host computer includes, without limitation, the previously mentioned devices that may interface to hard disk drives or other data storage devices.

Host computer 120 has a central processing unit (CPU) 210 coupled to various other components by system bus 212. An operating system 240, runs on CPU 210 and provides control of host computer 120 and the attached hard disk drives 220 and 221. Disk drives 220 and 221 may each comprise one or more disk drives 99 to provide a data storage device to host computer 120. Keyboard 224 and mouse 226 are connected to system bus 212 via user interface adapter 222.

Read only memory (ROM) 216 is coupled to system bus 212 and includes a basic input/output system (BIOS) that controls certain functions of computer 120. Random access memory (RAM) 214, I/O adapter 218, and communications adapter 234 are also coupled to system bus 212. It should be noted that software components including operating system 240 and application 250 are loaded into RAM 214, which is the main memory of computer 120. I/O adapter 218 and Communications adapter 234 are two examples of data storage device interfaces that may be used to interface and couple disk drives 220, 221 to host computer 120. I/O adapter 218 may be a small computer system interface (SCSI) adapter. SCSI cable 260 is connected between I/O Adapter 218 and Host-Device Interface 110 of FIG. 3 so that host computer 120 communicates with disk drive 220. Similarly, communications adapter 234 communicates with Network Attached Storage (NAS) disk drive 221 via network 261. Communications adapter 234 may be an Ethernet, Fiber Channel, ESCON, FICON, Wide Area Network (WAN), or TCP/IP interface. Additionally, other embodiments of data storage device interfaces, cables, protocols, etc., may be used to interface and couple disk drives 220, 221 to host computer 120, either using host device interface 110 or another equivalent interface, without limitation. A display monitor 238 is connected to system bus 212 by display adapter 236. In this manner, a user is capable of receiving visual messages concerning the disablement of the write-mode of disk drives 220 and 221.

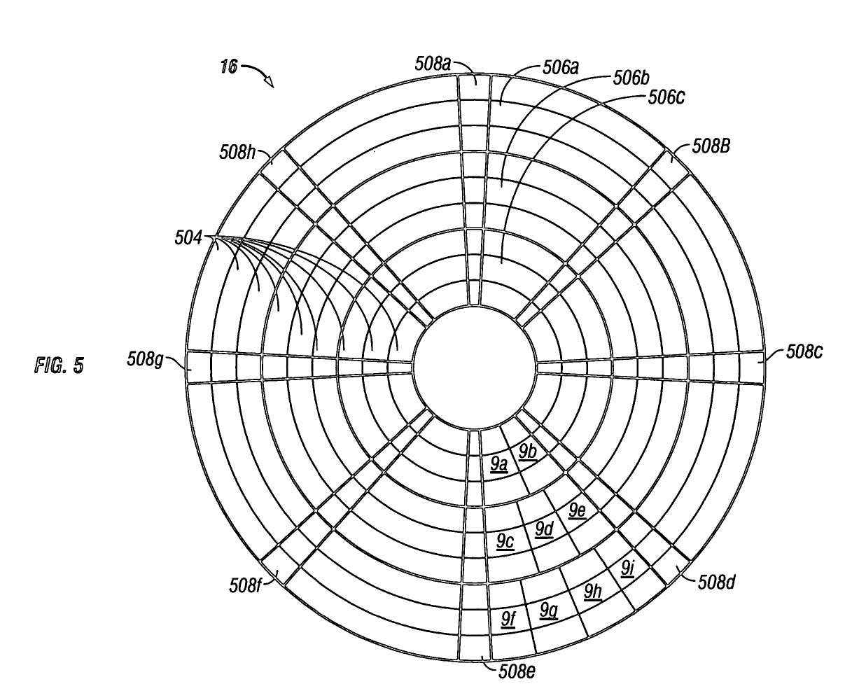

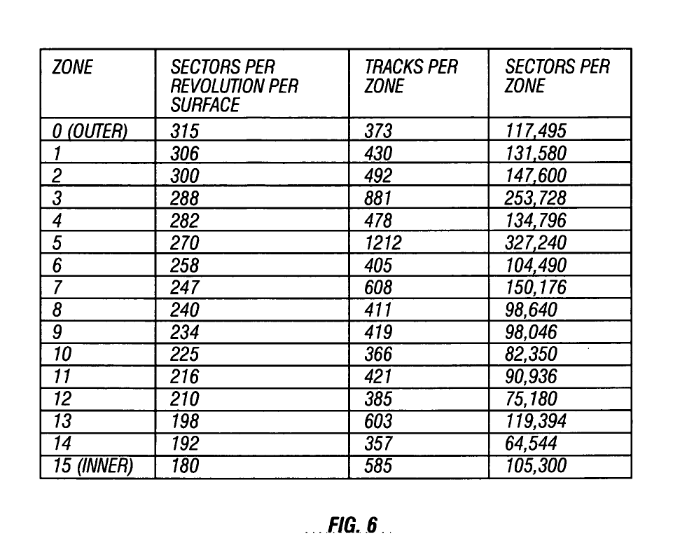

FIG. 5 illustrates an arrangement of a recording surface of disk 16 divided into concentric circular “tracks” on the disk surface. Disk 16 rotates at a constant angular velocity (CAV). It is divided up into zones 506a, 506b, and 506c, so the overall format of disk 16 is zoned constant angular velocity (ZCAV). Each zone is divided into data sectors laid out on concentric tracks 504. Alternately, spiral tracks may be used. In a given angular region, outer zone 506a has data sectors 9f, 9g, 9h, and 9i; middle zone 506b has data sectors 9c, 9d, and 9e; and inner zone 506c has data sectors 9a and 9b. A logical block address (LBA) is used to address a specific data sector 9a-9h. A data sector is the smallest logical unit that can be accessed on the disk. The size of a data sector is typically 512 bytes. As can be seen in FIG. 5, there are more data sectors per track in the outer zones than in the inner zones. This is better shown in FIG. 6. Processor 100 (FIG. 3) maps the LBA locations for disk drive 99 from information stored in memory 102 that is equivalent to that shown in FIG. 6.

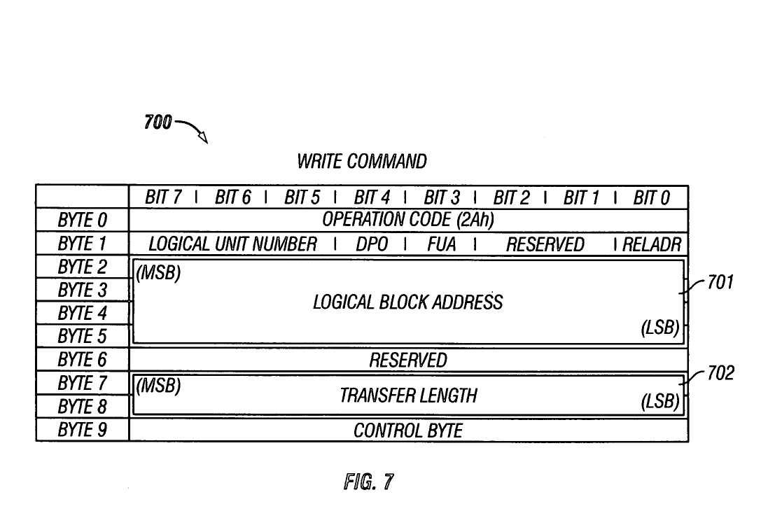

Commands are transmitted and received between host computer 120 and disk drives 220, 221 in a bidirectional manner to facilitate reading and writing data. Various communication interfaces and protocols may be used without limitation for the present invention, for example, SCSI commands. An example of a write command is the WRITE command 700 is shown in FIG. 7. WRITE command 700 includes a starting LBA address 701 of the command and a transfer length 702. For FBA (fixed block length) addressing, transfer length 702 is in multiples of the fixed block length, which is identical to an incremental LBA transfer length. The block length for a typical hard disk drive is 512 bytes, which is called a FBA. Partial blocks are not written, therefore the transfer length is in multiples of 512 bytes. Thus, the last LBA written is the sum of the starting LBA address 701 and the incremental LBA transfer length 702. Processor 100 maps the LBA to a specific data position (physical sector) on one of the disk surfaces. In this example, the LBA's are preferably mapped in tracks, shown in FIG. 5, and cylinders. Cylinders are logically formed from similar tracks on each data surface (of multiple disks) in hard disk drive 99, to enable data to be written on the similar tracks of different disk surfaces via head switching rather than seeking, as head switching is often faster than seeking.

FIG. 6 comprises a table showing the number of sectors per track, tracks per zone, and sectors per zone, per disk recording surface, for fifteen different zones, numbered from zero for the outermost zone to the highest number zone 15, which is the innermost zone. The second column shows that the outermost zones have a higher number of sectors per disk revolution than the inner zones, as the tracks in the outermost zones have a greater circumference, thereby allowing more sectors than the inner zones. The third column shows the number of tracks in a zone. Multiplying the second and third columns provides the sectors per zone as shown in the fourth column. The number of sectors of an inner zone may exceed the sectors in an outer zone, if the inner zone includes more tracks than the outer zone.

Processor 100 accesses memory 102 to obtain the information necessary (illustrated in FIG. 6), to locate a specific LBA. Starting at outer zone 0, the processor 100 uses the number of sectors per revolution (or sectors per track) and the number of tracks in that zone to locate a specific LBA. For example, if the desired LBA is located within zone 0, processor 100 may implement a procedure to divide the LBA by the sectors per revolution and the number of surfaces to obtain the number of tracks to traverse or seek across. The remainder of this first division must be divided by the number of sectors per revolution to give the destination disk surface. The remainder of this second division minus one gives the number of sectors to skip over in that destination track in order to reach the desired LBA. For example, to start writing at LBA 207, on a disk drive with 2 surfaces (1 disk) the following procedure could be used. In this first zone, there are 30 sectors per track and performing the division of 207/30, results in 6+27/30. Thus, 6 complete tracks are bypassed, 3 tracks on each of the 2 surfaces. The writing begins on LBA 27 of the 7^{th} track, which is the 4^{th} track on surface 0.

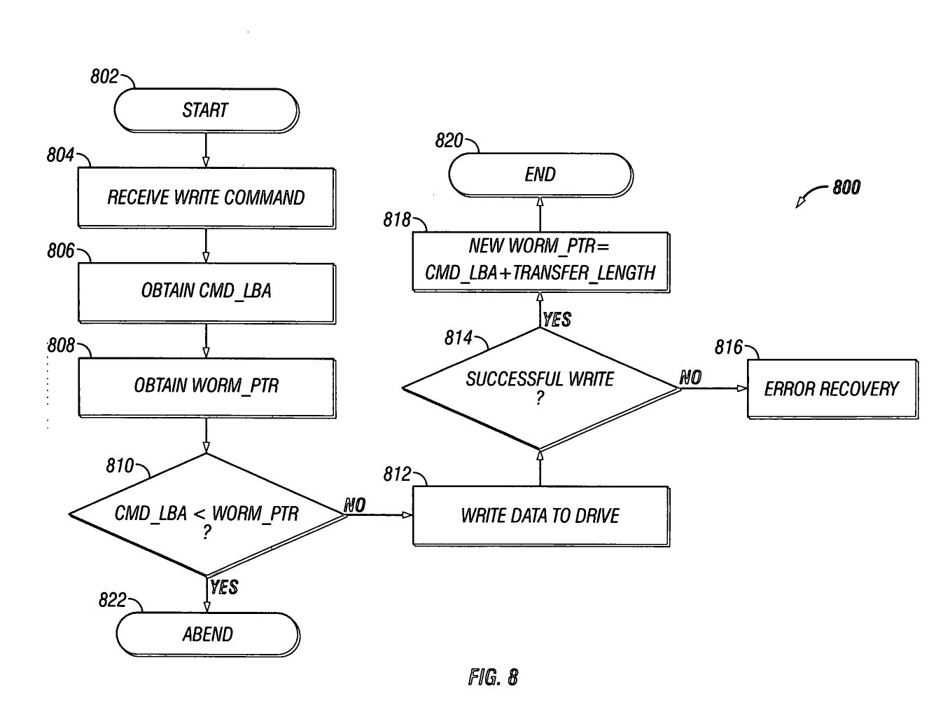

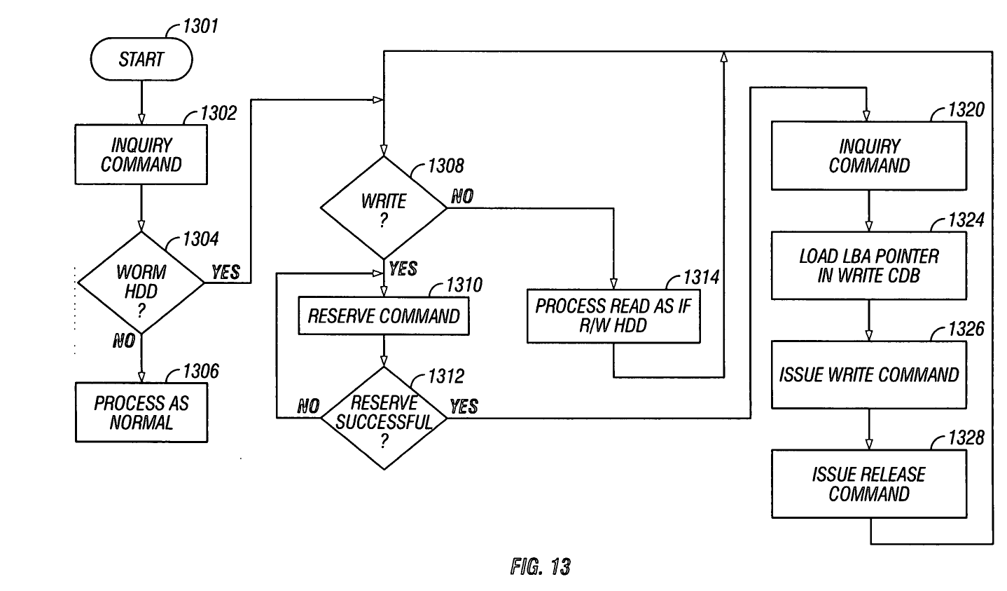

FIG. 8 shows flowchart 800 that describes one example of a process for direct writing of WORM data to disk 16. The process begins with step 802. Step 802 flows to step 804, where the WORM write command is received by disk drive 99, for example, disk drive 220 or 221. Before disk drive 99 receives the WORM write command a series of commands from the host and responses from disk drive 99 are executed to prepare disk drive 99 for the WORM write command (explained below with reference to FIG. 13). After disk drive 99 receives the WORM write command, the process flows to step 806, where the command LBA (CMD_LBA) is obtained from the received WORM write command. Processor 100 and host device interface 110 are coupled and may be used together or separately to obtain the starting LBA and the LBA transfer length from the WORM write command received by drive 99 through host device interface 110. CMD_LBA is the starting LBA where WORM data will be written to the recording surface of disk 16. For example, for the WRITE command 700, illustrated in FIG. 7, CMD_LBA is obtained from logical block address 701. The process then flows to step 808, where the (WORM pointer) WORM_PTR is retrieved from WORM pointer memory 103 by for example, processor 100. WORM_PTR is one LBA past the last LBA of WORM data written to disk drive 99. Numerically, WORM_PTR represents the first rewritable LBA on the disk. Thus, all LBA numbers smaller than WORM_PTR cannot be written and are considered WORM and are LBAs that comprise data that cannot change. All LBAs greater than or equal to WORM_PTR are considered rewritable. Each time WORM data is written to disk drive 99, a new value for WORM_PTR is stored in memory 103.

The process then flows to decision step 810, where the determination is made whether CMI_LBA is numerically less than WORM_PTR. If the determination in step 810 is yes, the process abends to step 822 to abort the write command because the host computer is attempting to rewrite data in the WORM area of disk drive 99. This step provides the assurance that WORM data cannot be rewritten or altered. This is because WORM_PTR is retrieved from an unalterable memory, for example, a PROM. Information may be stored only once in a PROM and may not be changed or altered after storage. Each time WORM data is written to disk drive 99 a new WORM_PTR is stored in worm pointer memory 103, by for example, processor 100. Once stored, each WORM_PTR cannot be altered. The result is that an audit trail is created showing the starting LBA of each data set stored on the recording surface of disk 16. In addition, a date stamp may be also stored in conjunction with each WORM pointer memory entry to further provide a record of data storage. The date stamp could comprise the date and time that each WORM pointer is written to memory to provide further confirmation of valid WORM data for audit purposes. The date stamp could be provided from a real time clock associated with processor 100, host computer, etc. The date stamp could be stored in WORM pointer memory 103, or another memory device associated with disk drive 99. The memory device for the date stamp storage may be in a sealed portion of disk drive 99 or other measures may be used to ensure that the date stamp may not be altered. If at step 810 processor 100 determines that the starting LBA is greater than or equal to WORM_PTR then the determination in step 810 is “No” and the process flows to step 812 to execute the write command and write the data to disk drive 99. The data is written on recording surface of disk 16 at the starting LBA that is equal to CMD_LBA. The process then flows to decision step 814, to determine if the data written to the recording surface of disk 16 was successful. This determination could be made by performing a write-verification procedure or if no errors occurred upon executing the write command or a combination thereof. One example of a write-verification procedure is to read back the data written and compare it to the original data.

FIG. 16 shows an example of a write verify command 1600 that may be applied at step 814. In FIG. 16, logical block address 1601 and transfer length 1602 are shown, and these are completely analogous to logical block address 701 and transfer length 702 of write command 700 of FIG. 7. In FIG. 16, byte check (BytChk) 1603 is either a zero or a one. The preferred value for byte check 1603 is one, where a byte-by-byte comparison of the data written on the medium and the data transferred by the host is executed. If the byte-by-byte comparison is unsuccessful for any reason, disk drive 99 returns a CHECK CONDITION STATUS response with the sense key set to MISCOMPARE to host computer 120. Upon detection of the MISCOMPARE, step 816 is executed to enable the subsequent error recovery.

If the determination is that the write was not successful in step 814, for example, if at least one error occurred upon executing the write command, then the process flows to error recovery step 816. The error recovery could consist of a procedure to attempt to rewrite the data in the exact same location (beginning at the starting LBA). If the rewrite failed at the exact same location, then the host could increment the starting LBA to be the first LBA after where the data could not be written or any LBA greater than the starting LBA. If the determination is that the write was successful in step 814, the process flows to step 818, where the new WORM_PTR is calculated to be the CMD_LBA added to a transfer length. The transfer length is measured in incremental LBAs. The new WORM_PTR is stored in WORM pointer memory 103. The process then ends in step 820. Thus, all data written per algorithm 800 is always WORM.

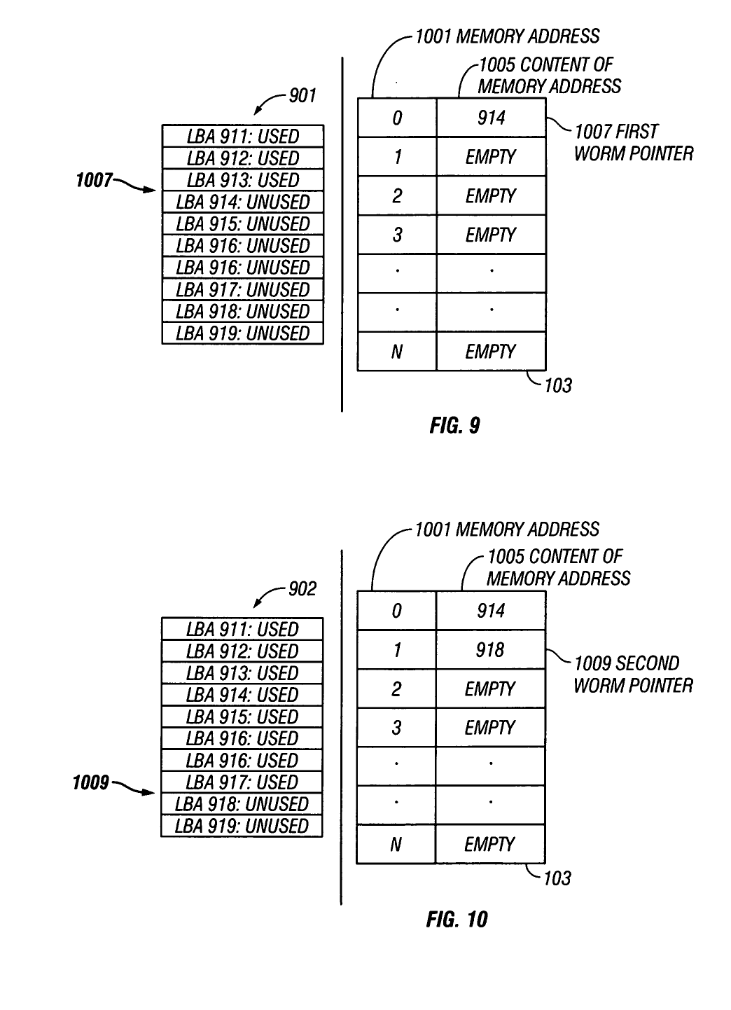

To more fully understand the operation of the present invention, illustrations of example LBAs 901 and example contents of pointer memory 103 are shown in FIG. 9 and 10 before and after a write operation is executed on drive 99. On the left hand side of FIG. 9 sequential LBAs 901 are illustrated in table form. LBAs 901 include used (or written to) LBAs 911-913 and unused LBAs 914-919. On the right hand side of FIG. 9, the associated layout of memory 103 corresponding to LBAs 901 is shown. First WORM pointer 1007 shows the demarcation between the used region and the unused region.

On the left had side of FIG. 10 sequential LBAs 902 are illustrated in table form. LBAs 902 include used (or written to) LBAs 911-917 and unused LBAs 918-919. On the right hand side of FIG. 10, the associated layout of WORM pointer memory 103 corresponding to LBAs 902 is shown. Second WORM pointer 1009 shows the demarcation between the used region and the unused region.

With reference to FIGS. 8, 9 and 10 an example of the process to execute a write command of four blocks (four LBAs) of data is presented to illustrate the operation of the present invention. In this example, LBA 701 (FIG. 7) is the CMD_LBA in step 806 of FIG. 8. For this example the value of CMD_LBA is 914. From 901 in FIG. 9, WORM_PTR 1007 has a value of 914 as a result of executing step 808 in FIG. 8.

Previous to executing the write command for this example, the LBAs 901 and pointer memory 103 are in the states shown in FIG. 9. Only a limited number of the total number of memory locations and LBAs are shown in FIGS. 9 and 10 for simplicity. This example is for illustration purposes and the memory address, memory contents and nomenclature may vary without limitation. The states shown in FIG. 9 may be the result of previous write operations. Memory 103 comprises memory address 1001 and contents of memory address 1005. First WORM_PTR 1007 in memory 103 is located at a memory address 1005 of 0. The contents of memory address 1005 comprises a value of 914 for first WORM_PTR 1007. LBA 914 is the next unused LBA. Memory addresses and contents are typically represented by binary, octal or hexadecimal number systems. For ease of understanding the decimal number system is used herein, without limitation. The next and subsequent memory addresses in memory 103 are empty indicating that no WORM pointers are stored in these empty locations.

At step 804 the write command was received and at step 806 CMI_LBA (with a value of 914) was obtained from the write command. At step 808 first WORM_PTR 1007 is obtained with a value of 914. CMD_LBA and WORM_PTR both having equal values of 914, results in a “no” determination at decision step 810 of FIG. 8 allowing step 812 to execute, resulting in writing data to drive 99. Additionally, in this example, transfer length 702 has the numerical value of four to write four blocks (four LBAs) of WORM data. Upon the completion of writing the four LBAs of WORM data, the states of LBAs and worm pointers are shown in FIG. 10. If the write was successful then execution of step 818 results in the state shown in FIG. 10. LBAs 902 now comprises used LBAs 911-917 and unused LBAs 918-919. The numerical value of second WORM_PTR 1009 is 918, which is the numerical sum of CMDILBA (914) and the transfer length of four, per step 818 of FIG. 8.

The WORM_PTR 1009 stored in memory address 1 of memory 103 (the second memory address) is 918, which is consistent with the writing of 4 LBAs of data in FIG. 9. Second WORM_PTR 1009 comprises an LBA number of 918 as shown on the right hand side of FIG. 10. For this example, and for the present state after executing the write command described above, WORM_PTR contains the largest LBA number for use in determining the boundary between WORM data and unwritten LBAs for disk drive 99.

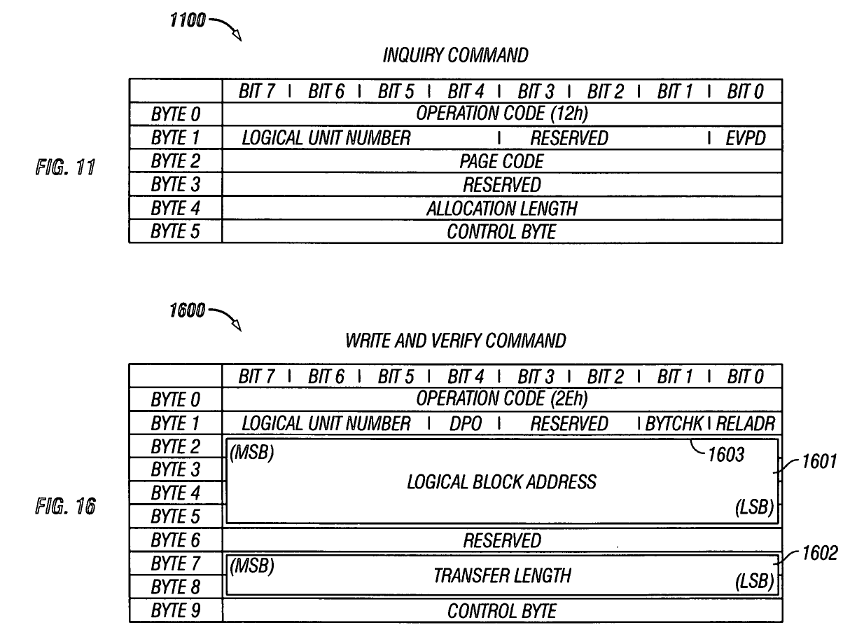

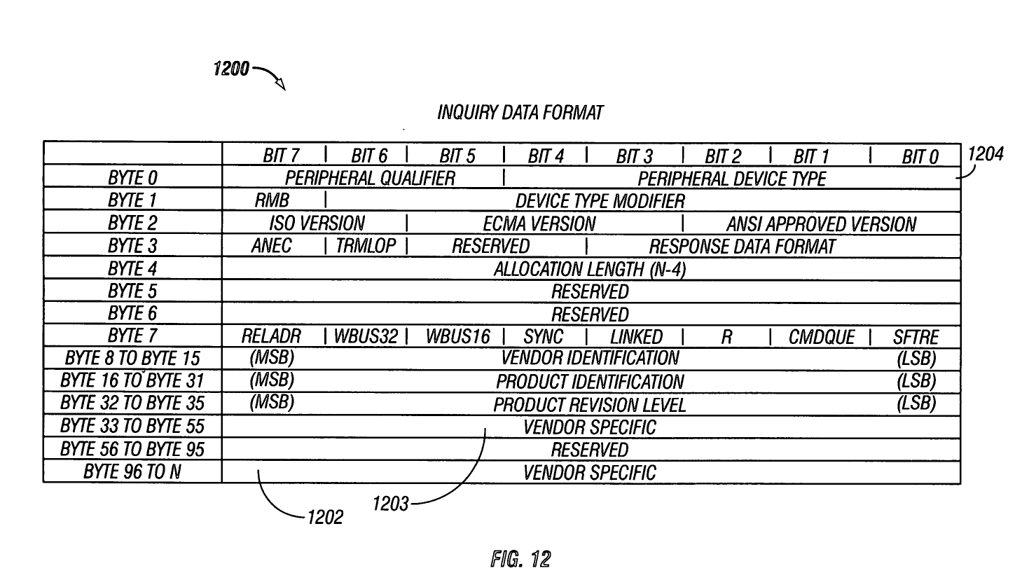

The WORM pointer is available to host computer 120 by use of commands and responses to/from disk drive 99. For example, INQUIRY command 1100, shown in FIG. 11 may be used by host computer 120 to obtain the current value of the worm pointer. The following description will proceed using INQUIRY command 1100; however, other commands issued with various host computer/disk drive protocols may be used without limitation. When Inquiry command 1100 is issued from a device, for example host computer 120, the data that is returned to host computer 120 by drive 99 is shown in FIG. 12. The returned data 1200 contains vender specific reserved fields 1202 and 1203 that can be utilized in this case for returning the WORM pointer. Drive 99 sends the data shown in FIG. 12 to host computer 120. For example, the Peripheral Device Type field 1204, byte 0, bits 0-4, may be set to 04, denoting a WORM device, and the vender specific field 1202, bytes 36-55, may be set to the current value of the worm pointer by drive 99. Other protocols and commands can alternately be used instead of or inclusive of the Inquiry command. Host computer 120 accesses the WORM pointer value, for example, through use of a file system, to enable host computer 120 to provide the correct values required for write command 700.

FIG. 13 shows a flowchart 1300 of an example of a process executed by host computer 120 to access hard disk drive 99 as a WORM drive. Host computer 120 may use a file-system/device-driver, software, firmware, etc to access hard disk drive 99. The process starts at step 1301, and flows to step 1302, where Inquiry command 1100 is issued by host computer 120. Inquiry command 1100, may be used by host computer 120 (or another device that has accesses to disk drive 99) to determine the device type of drive 99. In response to receiving inquiry command 1100 from host computer 120, drive 99 sends a device type to host computer 120. The device type of drive 99 may be encoded in the peripheral device type field 1204 (FIG. 12). The device type indicates to host computer 120 whether hard disk drive 99 supports storing data in a WORM format. The process flows to decision step 1304, where a determination is made by host computer 120, by analyzing the inquiry data 1200 returned from hard disk drive 99 as to whether or not hard disk drive 99 supports storing data in a WORM format. Specifically, for this example, the peripheral device type 1204 is interrogated by host computer 120 for the device type. If in step 1304 the device type is not WORM, then control transfers to step 1306, where hard disk drive 99 is processed as a rewritable hard disk drive. If the inquiry data 1200 and peripheral device type 1204 indicates a WORM HDD in step 1304, then the process flows to decision step 1308, where the host determines if the next command that will be issued to disk drive 99 is a read or write command. If the next command that will be issued to disk drive 99 is not a write command, then control transfers from step 1308 to step 1314, and the read command is processed as if the WORM HDD were a normal Read/Write HDD. From step 1314, the process flows back to step 1308 for additional I/O command processing.

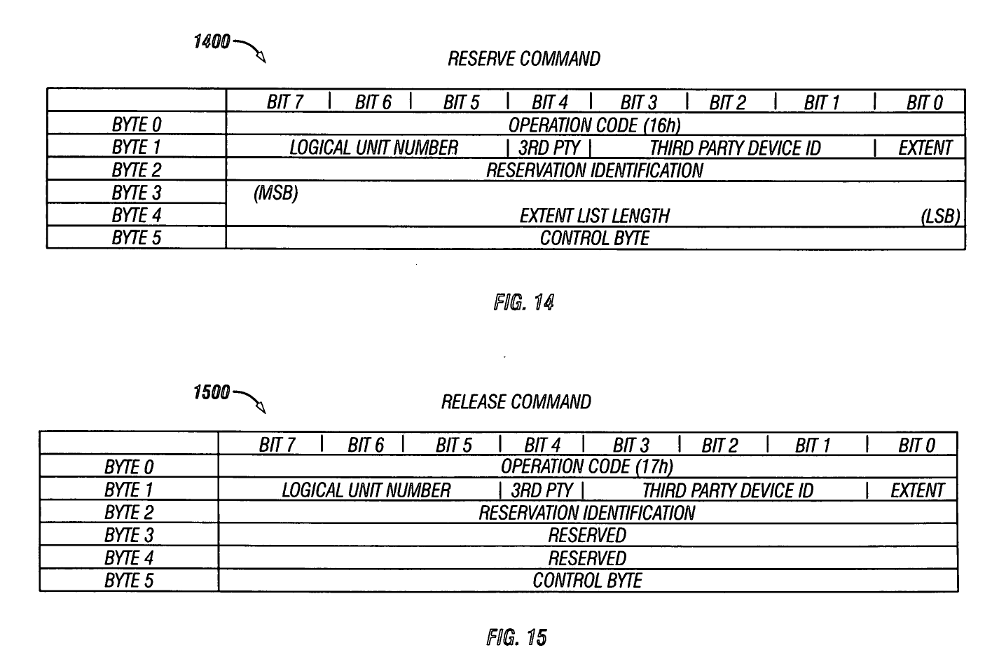

If the command to be issued is a write in step 1308, then the process flows to step 1310, where a reserve command, (for example the SCSI reserve command 1400 shown in FIG. 14) is sent to reserve disk drive 99 to ensure that no other device, for example, another host computer, is able to write to disk drive 99 while the current write command is processed. This prevents two different initiators, for example, two host computers, from writing to the HDD at the same time and possibly overwriting data as a result of the WORM pointer not being updated correctly during the transient period when both devices may be writing data. The reserve command is examined by host computer 120 for successful completion at decision step 1312. If at step 1312, the reserve command is not successful, control is transferred to step 1310 where the reserve command is retried. Steps 1310 and 1312 are executed until the reserve command is successful or until a time-out or other condition causes host computer 120 to stop executing steps 1310 and 1312. If at step 1312 the reserve command is successful, then the process flows to 1320, where a second inquiry command 1100 is issued form host computer 120 to disk drive 99. This second inquiry command 1100 is issued to determine the LBA that disk drive 99 will allow WORM data to be written to. Second inquiry command 1100 is needed because until disk drive 99 is reserved, WORM_PTR in disk drive 99 may change as a result of the execution of other write commands or other conditions. In response to receiving the second inquiry command from host computer 120, disk drive 99 sends the worm pointer to host computer 120, for example by the Inquiry Data format 1200 reponse. The data that is returned in the Inquiry Data format 1200 contains the current WORM_PTR, for example, in positions 1202 or 1203 (FIG. 12). The WORM_PTR is equal to the last written LBA incremented by one. In step 1324, host computer 120, inserts the value of WORM_PTR obtained at step 1320 into Write Command 700 at the LBA 701 (FIG. 7). At step 1326, the Write Command 700 is issued by host computer 120. At step 1328, a release command, for example, SCSI Release command 1500 shown in FIG. 15 is issued form host computer 120 to disk drive 99 to enable other devices (e.g. host computers, etc.) to access disk drive 99. The process then flows to back to step 1308 for further I/O command processing.

The invention disclosed herein may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium (e.g., magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the present invention, and that the article of manufacture may comprise any information bearing medium known in the art.

While the preferred embodiments of the present invention have been illustrated in detail, it should be apparent that modifications and improvements may be made to the invention without departing from the spirit and scope of the invention. For example, the data could be alternately be stored holographically, magneto-optically, or on phase-change optical media. All of these alternate media are reversible or rewritable. This invention would apply to all of these media as long as memory 103 was stored in an area not accessible to the customer, such as enclosed inside of a sealed container such as shown in FIGS. 1 and 2.

1. A method for writing data on a data storage device, comprising:
said data storage device receiving a write command;
obtaining a starting LBA and a LBA transfer length from said write command;
obtaining a first WORM pointer from a WORM pointer memory; and
in response to said starting LBA being greater than or equal to said WORM pointer, executing said write command.

2. The method of claim 1, wherein executing said write command writes said data as WORM data on said data storage device.

3. The method of claim 1, further comprising:
in response to said starting LBA being less than said first WORM pointer, aborting said write command.

4. The method of claim 1, further comprising:
in response to determining that said write command executed without errors:
calculating a second WORM pointer which is equal to the numerical sum of said first WORM pointer and said transfer length; and
storing said second WORM pointer in said WORM pointer memory.

5. The method of claim 1, further comprising:
in response to determining that said write command executed without errors:
calculating a second WORM pointer which is equal to the numerical sum of said first WORM pointer and said transfer length;
storing said second WORM pointer in said WORM pointer memory; and
storing a date stamp for each said WORM pointer stored in said WORM pointer memory.

6. The method of claim 1, further comprising:
in response to determining that said write command executed with at least one error, rewriting said data.

7. The method of claim 1, further comprising:
in response to determining that said write command executed with at least one error, rewriting said data beginning at said starting LBA.

8. The method of claim 1, further comprising:
in response to determining that said write command executed with at least one error, rewriting said data beginning at an LBA that is greater than said starting LBA.

9. The method of claim 1, further comprising:
in response to receiving a first inquiry command from a host computer,
sending a device type to said host computer.

10. The method of claim 9, further comprising:
in response to receiving a second inquiry command from said host computer,
sending a worm pointer to said host computer.

11. A method for a host computer to write data to a data storage device, comprising:
said host computer sending a first inquiry command to said data storage device;
receiving a response from said data storage device to said first inquiry command;
determining a device type of said data storage device from said response to said first inquiry command;
sending a reserve command to said data storage device to reserve said data storage device;
sending a second inquiry command to said data storage device;
receiving a response from said data storage device to said second inquiry command;
obtaining a starting LBA from said response to said second inquiry command;
embedding said starting LBA in a write command; and
writing said data to said data storage device using said write command.

12. The method of claim 11, wherein said write command writes said data as WORM data on said data storage device.

13. A data storage device, comprising:
a data storage media for storage of data;
a processor for controlling said data storage device;
a WORM pointer memory coupled to said processor for storage of a WORM pointer;
a host device interface coupled to said processor for receiving commands from a host computer.

14. The data storage device of claim 13, wherein said data is stored as WORM data on said data storage media.

15. The data storage device of claim 13, wherein said processor obtains a starting LBA and a LBA transfer length from a write command received by said host device interface, obtains a first WORM pointer from said WORM pointer memory and in response to said starting LBA being greater than or equal to said first WORM pointer, executes said write command.

16. The data storage device of claim 13, wherein said WORM pointer memory is an EPROM.

17. The data storage device of claim 13, wherein said WORM pointer memory is a PROM.

18. The data storage device of claim 13, wherein said WORM pointer memory is a FLASH memory.

19. The data storage device of claim 13, wherein said WORM pointer memory is located inside a sealed portion said data storage device.

20. The data storage device of claim 13, further comprising:
a memory device for storage of a date stamp associated with each said WORM pointer.

21. A data storage system, comprising:
a host computer comprising a data storage device interface;
a data storage device comprising:
a data storage media for storage of data;
a processor for controlling said data storage device;
a WORM pointer memory coupled to said processor for storage of a WORM pointer;
a host device interface coupled to said processor for sending and receiving commands with respect to said host computer.

22. The data storage system of claim 21, wherein said data is stored as WORM data on said data storage media.

23. The data storage system of claim 21, wherein said processor obtains a starting LBA from a write command received by said host device interface, obtains a first WORM pointer from said WORM pointer memory and in response to said starting LBA being greater than or equal to said WORM pointer, executes said write command.

24. An article of manufacture comprising a data storage medium tangibly embodying a program of machine-readable instructions executable by a digital processing apparatus to perform method steps for writing data on a data storage device, said steps comprising:
said data storage device receiving a write command;
obtaining a starting LBA and a LBA transfer length from said write command;
obtaining a first WORM pointer from a WORM pointer memory; and
in response to said starting LBA being greater than or equal to said WORM pointer, executing said write command.

25. The article of manufacture of claim 24, wherein executing said write command writes said data as WORM data on said data storage device.

26. The article of manufacture of claim 24, wherein said method steps further comprises:
in response to said starting LBA being less than said first WORM pointer, aborting said write command.

27. The article of manufacture of claim 24, wherein said method steps further comprises:
in response to determining that said write command executed without errors:
calculating a second WORM pointer which is equal to the numerical sum of said first WORM pointer and said transfer length; and
storing said second WORM pointer in said WORM pointer memory.

28. The article of manufacture of claim 24, wherein said method steps further comprises:
in response to determining that said write command executed without errors:
calculating a second WORM pointer which is equal to the numerical sum of said first WORM pointer and said transfer length;
storing said second WORM pointer in said WORM pointer memory; and
storing a date stamp for each said WORM pointer stored in said WORM pointer memory.

29. The article of manufacture of claim 24, wherein said method steps further comprises:
in response to determining that said write command executed with at least one error, rewriting said data.

30. The article of manufacture of claim 24, wherein said method steps further comprises:
in response to determining that said write command executed with at least one error, rewriting said data beginning at an LBA that is greater than or equal to said starting LBA.

31. The article of manufacture of claim 24, wherein said method steps further comprises:
in response to receiving a first inquiry command from a host computer,
sending a device type to said host computer.

32. The article of manufacture of claim 31, wherein said method steps further comprises:
in response to receiving a second inquiry command from said host computer,
sending a worm pointer to said host computer.

33. An article of manufacture comprising a data storage medium tangibly embodying a program of machine-readable instructions executable by a digital processing apparatus to perform method steps for a host computer to write data to a data storage device, said method steps comprising:
said host computer sending a first inquiry command to said data storage device;
receiving a response from said data storage device to said first inquiry command;
determining a device type of said data storage device from said response to said first inquiry command;
sending a reserve command to said data storage device to reserve said data storage device;
sending a second inquiry command to said data storage device;
receiving a response from said data storage device to said second inquiry command;
obtaining a starting LBA from said response to said second inquiry command;
embedding said starting LBA in a write command; and
writing said data to said data storage device using said write command.

34. The article of manufacture of claim 33, wherein said write command writes said data as WORM data on said data storage device.
